(19) United States
(12) Patent Application Publication
(10) Pub. No.: US 2009/0292446 A1
(43) Pub. Date: Nov. 26, 2009

(54) CONTROL APPARATUS AND CONTROL METHOD OF INTERNAL COMBUSTION ENGINE

(75) Inventor: Toshihiko Tanaka, Aichi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toyota Jidsha Kabushiki Kaisha, Toyota-shi (JP)

(21) Appl. No.: 12/302,178

(22) PCT Filed: Oct. 4, 2007
(86) PCT No.: PCT/IB07/02946

§ 371 Date: Nov. 24, 2008

(30) Foreign Application Priority Data
Oct. 6, 2006 (JP) 2006-275391

(51) Int. Cl. F02D 43/00; F02D 23/00

(52) U.S. Cl. 701/103; 60/602

(57) ABSTRACT

A control apparatus of an internal combustion engine performs control to warm up a catalyst. More specifically, the control apparatus keeps a wastegate valve open when the temperature of the catalyst is less than a predetermined temperature and closes the wastegate valve when the temperature of the catalyst becomes equal to or greater than the predetermined temperature. The control apparatus executes control to increase and decrease the fuel injection quantity such that the internal combustion engine alternately switches between lean burn and rich burn when the wastegate valve is closed. Accordingly, rich gas and lean gas can be reliably mixed in the catalyst, and CO can be reliably combusted in the catalyst. Therefore, the catalyst can be promptly warmed up while CO, HC, and the like can be appropriately suppressed from flowing through the catalyst.

### BACKGROUND OF THE INVENTION

1. Field of the Invention

The invention relates to a control apparatus and a control method of an internal combustion engine, which performs control to promptly warm up a catalyst.

2. Description of the Related Art

Catalyst warm-up control that raises the temperature of an exhaust gas control catalyst to activation temperature is performed at times such as after startup of an internal combustion engine. For example, Japanese Patent Application Publication No. 9-88663 (JP-A-9-88663) describes technology for promptly warming up a catalyst by increasing and decreasing the fuel injection quantity to supply the catalyst with oxygen from lean burn and a combustible component (such as CO (carbon monoxide)) from rich burn. Executing this kind of control promotes the oxidation reaction of the CO in the catalyst, and the heat generated by this oxidation reaction promotes catalyst warm-up. Also, Japanese Patent Application Publication No. 2001-107722 (JP-A-2001-107722) describes technology for warming up a catalyst by opening a valve (a wastegate valve) provided in a passage that bypasses a supercharger when the catalyst is not warmed up.

However, when performing the control described in JP-A-9-88663, emissions may be adversely effected by CO and HC and the like escaping from (i.e., flowing through) the catalyst. It is thought that this is outflow of CO and HC and the like is due to insufficient mixing of rich gas (i.e., gas supplied to the catalyst during rich burn) and lean gas (i.e., gas supplied to the catalyst during lean burn) in the catalyst or to the catalyst not having reached the temperature at which these gases react. Also, with the technology described in JP-A-2001-107722 as well, it is difficult to appropriately suppress CO and HC and the like from escaping from (i.e., flowing through) the catalyst when the catalyst is warming up.

### SUMMARY OF THE INVENTION

This invention thus provides a control apparatus of an internal combustion engine, which is capable of promptly warming up a catalyst while appropriately suppressing CO and MC and the like from flowing through the catalyst.

A first aspect of the invention relates to a control apparatus of an internal combustion engine, which includes a wastegate valve control portion that controls the opening and closing of a wastegate valve provided in a bypass passage that connects a portion of an exhaust passage upstream of a supercharger with a portion of the exhaust passage downstream of the supercharger, thereby bypassing the supercharger; and a fuel injection control portion that controls an increase and decrease of a fuel injection quantity. The wastegate valve control portion keeps the wastegate valve open when a temperature of a catalyst provided in the exhaust passage is less than a predetermined temperature and closes the wastegate valve when the temperature of the catalyst becomes equal to or greater than the predetermined temperature. The fuel injection control portion increases and decreases the fuel injection quantity such that the internal combustion engine alternately switches between lean burn and rich burn when the wastegate valve is closed by the wastegate valve control portion.

The control apparatus of an internal combustion engine according to this first aspect is used to control an internal combustion engine having a supercharger and a wastegate valve so as to warm up a catalyst. According to this aspect, CO that is produced as a result of the control executed by the fuel injection control portion can be reliably combusted in the catalyst (i.e., CO and O₂ can be reliably reacted). In addition, lean gas (such as O₂ (oxygen)) and rich gas (such as CO (carbon monoxide)) can be efficiently mixed in the catalyst. As a result, the catalyst can be warmed up promptly while appropriately suppressing CO and HC and the like from flowing through the catalyst.

In the first aspect described above, the fuel injection control portion may prohibit control that increases and decreases the fuel injection quantity when the catalyst temperature is less than the predetermined temperature.

In this structure, the internal combustion engine may be provided with a plurality of cylinders, and the fuel injection control portion may perform control to increase and decrease the fuel injection quantity such that each cylinder of the internal combustion engine alternately switches between lean burn and rich burn.

In the foregoing structure, the internal combustion engine may be provided with a plurality of cylinder groups in which a plurality of cylinders are arranged divided into two banks, and the fuel injection control portion may increase and decrease the fuel injection quantity such that rich burn is performed in the cylinder group forming one bank and lean burn is performed in the cylinder group forming the other bank alternately.

In the foregoing structure, the fuel injection control portion may increase and decrease the fuel injection quantity such that the internal combustion engine alternately switches between lean burn and rich burn every predetermined period of time.

In the foregoing structure, the fuel injection control portion may set the amount of increase and decrease of the fuel injection quantity based on at least one of an intake air amount, an intake pipe pressure, and a turbine speed of the supercharger.

In the foregoing structure, the fuel injection control portion may increase the amount of increase and decrease of the fuel injection quantity as the intake pipe pressure increases. Also, the fuel injection control portion may increase the amount of increase and decrease of the fuel injection quantity as the turbine speed of the supercharger increases.

According to the foregoing structure, the fuel injection control portion sets the amount by which the air-fuel ratio changes to the rich side and the lean side based on at least one of an intake air amount, an intake pipe pressure, and a turbine speed of the supercharger. For example, the fuel injection control portion executes control to gradually increase the amount that the fuel injection quantity is increased and decreased for each cylinder or each predetermined period of time when the turbine speed is increasing. Executing this kind of control enables rich gas and lean gas of amounts according to the turbine speed to be supplied to the supercharger, which enables the rich gas and the lean gas to be effectively mixed in the supercharger. As a result, rich gas and lean gas can be reliably mixed in the catalyst.

In the foregoing structure, the fuel injection control portion may provide a predetermined limit value for the fuel injection quantity and set the amount of increase and decrease of the fuel injection quantity such that the fuel injection quantity is maintained at the limit value when the fuel injection quantity reaches the limit value.

In the foregoing structure, the predetermined temperature may be a temperature at which CO in the exhaust gas is able to combust in the catalyst.

A second aspect of the invention relates to a control method for an internal combustion engine having a supercharger and a wastegate valve provided in a bypass passage that connects a portion of an exhaust passage upstream of a supercharger with a portion of the exhaust passage downstream of the supercharger, thereby bypassing the supercharger. This control method includes keeping the wastegate valve open when a temperature of a catalyst provided in the exhaust passage is less than a predetermined temperature and closing the wastegate valve when the temperature of the catalyst becomes equal to or greater than the predetermined temperature; and increasing and decreasing the fuel injection quantity such that the internal combustion engine alternately switches between lean burn and rich burn when the wastegate valve is closed.

### BRIEF DESCRIPTION OF DRAWINGS

The foregoing and further objects, features and advantages of the invention will become apparent from the following description of example embodiments with reference to the accompanying drawings, wherein like numerals are used to represent like elements and wherein:

FIG. 1 is a schematic diagram of the structure of a vehicle to which a control apparatus of an internal combustion engine according to an example embodiment of the invention has been applied;

FIG. 2 is a block diagram schematically showing an engine in this example embodiment of the invention;

FIG. 3 is a graph showing an example of fuel injection dither control in this example embodiment of the invention;

FIGS. 4A to 4E are graphs showing the basic flow of fuel injection dither control according to this example embodiment of the invention;

FIG. 5 is an example of a graph when the fuel injection dither amplitude is changed in this example embodiment of the invention;

FIG. 6 is a flowchart illustrating a catalyst warm-up routine according to the example embodiment of the invention; and

FIG. 7 is a flowchart illustrating the fuel injection dither control according to this example embodiment of the invention.

### DETAILED DESCRIPTION OF THE EMBODIMENTS

In the following description and the accompanying drawings, the present invention will be described in more detail in terms of example embodiments. First the overall structure of a system to which the control apparatus of an internal combustion engine according to an example embodiment of the invention has been applied will be described.

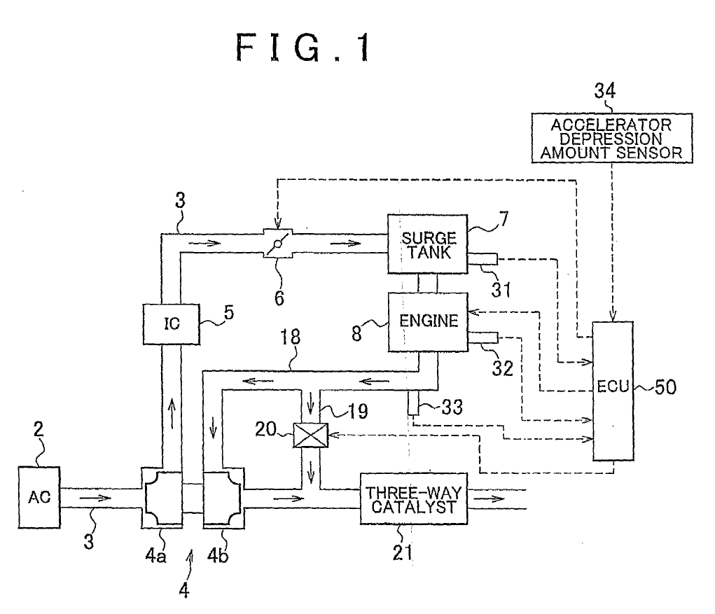

FIG. 1 is a schematic diagram of the structure of a vehicle to which a control apparatus of an internal combustion engine according to this example embodiment has been applied. In the drawing, the solid arrows indicate the flow of gas and the broken arrows indicate signal input and output.

The vehicle is mainly provided with an air cleaner (AC) 2, an intake passage 3, a turbocharger 4, an intercooler (IC) 5, a throttle valve 6, a surge tank 7, an engine (i.e., an internal combustion engine) 8, an exhaust passage 18, a bypass passage 19, a wastegate valve 20, a three-way catalyst 21, an intake air pressure sensor 31, a coolant temperature sensor 3), an oxygen sensor 33, an accelerator depression amount sensor 34, and an ECU (Engine Control Unit) 50.

The air cleaner 2 purifies air (intake air) drawn in from outside and supplies it to the intake passage 3. A compressor 4a of the turbocharger 4 is provided in the intake passage 3. The intake air is compressed (i.e., supercharged) by rotation of the compressor 4a. Moreover; the intercooler 5 which cools the intake air and the throttle valve 6 which regulates the amount of intake air supplied to the engine 8 are also provided in the intake passage 3.

Intake air that passes through the throttle valve 6 is first stored in the surge tank 7 formed in the intake passage 3, after which it flows into a plurality of cylinders, not shown, of the engine 8. The engine 8 generates power by burning an air-fuel mixture, which is a mixture of the supplied air and fuel, in the cylinders. The engine 8 is, for example, a gasoline engine or a diesel engine or the like. Exhaust gas produced by the combustion of this air-fuel mixture in the cylinders of the engine 8 is then discharged into the exhaust passage 18. Incidentally, the engine 8 performs various controls such as ignition timing control, fuel injection quantity control, and fuel injection timing control according to control signals supplied from the ECU 50.

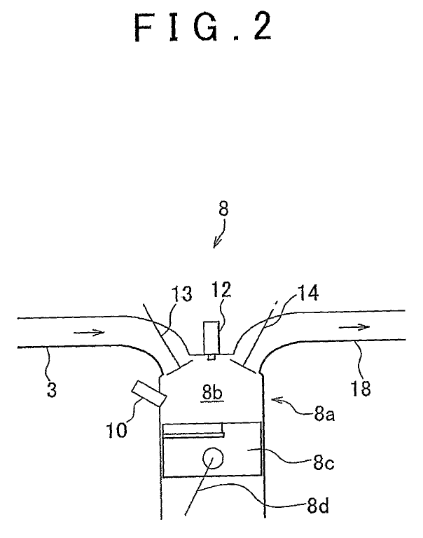

Here, the structure of the engine 8 will be described in detail with reference to FIG. 2. The engine 8 mainly includes a cylinder 8a, a fuel injection valve 10, a spark plug 12, an intake valve 13, and an exhaust valve 14. Incidentally, in FIG. 2, only one cylinder 8a is shown to simplify the description, but in actuality, the engine 8 has a plurality of the cylinders 8a.

The fuel injection valve 10 is a fuel injector that is provided in the cylinder 8a and injects fuel directly into a combustion chamber 8b of the cylinder 8a (i.e., performs in-cylinder injection). The fuel injection valve 10 is controlled by a control signal supplied from the ECU 50. That is, the ECU 50 executes fuel injection quantity control and the like. Incidentally, the engine 8 is not limited to having the fuel injection valve 10 that performs in-cylinder injection (i.e., direct injection). Alternatively or in addition, the engine 8 may have a fuel injection valve that performs port injection.

Air is supplied into the combustion chamber 8b of the cylinder 8a from the intake passage 3 while fuel is supplied into the combustion chamber 8b of the cylinder 8a from the fuel injection valve 10. The air-fuel mixture of the supplied air and fuel is ignited by a spark from the spark plug 12 and combusted in the combustion chamber 8b. This combustion forces a piston 8c to move in a reciprocating motion which is transmitted to a crankshaft, not shown, via a connecting rod 8d, thereby rotating the crank shaft. Incidentally, the spark plug 12 is controlled by a control signal supplied from the ECU 50. That is, the ECU 50 executes ignition timing control.

Further, the intake valve 13 and the exhaust valve 14 are provided in the cylinder 8a. The intake valve 13 is controlled open and closed to selectively allow and prevent communication between the intake passage 3 and the combustion chamber 8b. Similarly, the exhaust valve 14 is controlled open and closed to selectively allow and prevent communication between the exhaust passage 18 and the combustion chamber 8b.

Returning to FIG. 1, the other constituent elements of the vehicle will now be described.

Exhaust gas discharged from the engine 8 rotates a turbine 4b of the turbocharger 4 provided in the exhaust passage 18. The resultant rotational torque of the turbine 4b is transmitted to the compressor 4a in the turbocharger 4, causing it to rotate which compresses (supercharges) the intake air passing through the turbocharger 4.

The bypass passage 19 connects a portion of the exhaust passage 18 upstream of the turbocharger 4 with a portion of the exhaust passage 18 downstream of the turbocharger 4, thereby bypassing the turbocharger 4. The wastegate valve 20 is provided in the bypass passage 19. When the wastegate valve 20 is closed, exhaust gas flows into the turbocharger 4 and does not flow through the bypass passage 19. Conversely, when the wastegate valve 20 is open, exhaust gas also flows through the bypass passage 19, thus suppressing an increase in the rotation speed of the compressor 4a. That is, the pressure boost from the turbocharger 4 is suppressed. The ECU 50 controls this opening and closing of the wastegate valve 20.

Also, the three-way catalyst 21 which functions to purify the exhaust gas is also provided in the exhaust passage 18. More specifically, the three-way catalyst 21 is a catalyst that has a precious metal such as platinum or rhodium as the active component and removes oxides of nitrogen (NO_{X}), carbon monoxide (CO), and hydrocarbons (HC) and the like that are in the exhaust gas. Also, the ability of the three-way catalyst 21 to purify the exhaust gas changes depending on the temperature of the three-way catalyst 21. More specifically, as the temperature of the three-way catalyst 21 approaches the activation temperature, the ability of the three-way catalyst 21 to purify exhaust gas increases. Therefore, at times such as during a cold start, the temperature of the three-way catalyst 21 needs to be raised to the activation temperature. Incidentally, the apparatus used to purify the exhaust gas is not limited to the three-way catalyst 21. Also, the three-way catalyst 21 will hereinafter simply be referred to as “catalyst” and the reference numeral omitted.

The intake air pressure sensor 31 is provided in the surge tank 7 and detects the intake air pressure. This intake air pressure is the pressure corresponding to the pressure in the intake pipe. The coolant temperature sensor 32 detects the temperature of coolant used to cool the engine 8 (hereinafter, this temperature will be referred to as the “engine coolant temperature”). The oxygen sensor 33 is provided in the exhaust passage 18 and detects the oxygen concentration in the exhaust gas. Also, the accelerator depression amount sensor 34 detects the depression amount of the accelerator by a driver. The detection values detected by these sensors are supplied to the ECU 50 as detection signals.

The ECU 50 includes a CPU, ROM, RAM, and an A/D converter and the like, none of which are shown. The ECU 50 performs control in the vehicle based on output from the various sensors in the vehicle. In this example embodiment, the ECU 50 mainly controls the wastegate valve (hereinafter also referred to as “WGV”) 20 and the fuel injection valve 10. More specifically, the ECU 50 keeps the WGV 20 open when the catalyst temperature is less than a predetermined temperature, and closes the WGV 20 when the catalyst temperature becomes equal to or greater than the predetermined temperature. Incidentally, this predetermined temperature corresponds to a temperature at which CO in the exhaust gas can be combusted in the catalyst. Furthermore, when the catalyst temperature becomes equal to or greater than the predetermined temperature such that the WGV 20 closes, the ECU 50 performs control to increase and decrease the fuel injection quantity so that the engine 8 alternates between lean burn and rich burn (hereinafter this control will be referred to as “fuel injection dither control”). This kind of control is performed in order to promptly warm up the catalyst while appropriately suppressing CO and HC and the like from flowing out of the catalyst.

As described above, the ECU 50 functions as the control apparatus of an internal combustion engine of this invention. More specifically, the ECU 50 operates as a wastegate control portion and a fuel injection control portion.

Next, the fuel injection dither control executed by the ECU 50 described above will be described. In this example embodiment, the fuel injection dither control is executed to promptly warm up the catalyst at times such as during a cold start.

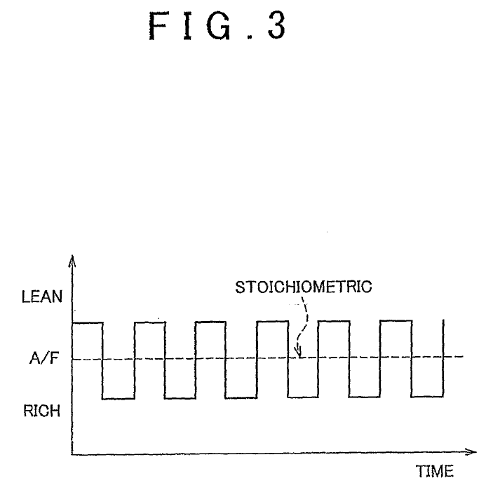

Here, basic fuel injection dither control will be described with reference to the graph in FIG. 3 which shows the change in the target air-fuel ratio when fuel injection dither control is performed. In FIG. 3 the horizontal axis represents time and the vertical axis represents the air-fuel ratio (A/F).

As shown in FIG. 3, in fuel injection dither control, control is performed to increase and decrease the fuel injection quantity so that the engine 8 alternates between lean burn and rich burn in each cylinder 8a or for each predetermined period of time. When this kind of control is executed, lean gas (O₂ (oxygen) and the like) is supplied to the catalyst during lean burn, and rich gas (CO (carbon monoxide) and the like) is supplied to the catalyst during rich burn, which promotes the reaction of CO and O₂ in a reaction (i.e., the oxidation reaction) in the catalyst. The heat generated by this oxidation reaction heats the catalyst, thereby promoting catalyst warm-up.

However, if fuel injection dither control is executed when the catalyst has not yet reached the temperature at which the rich gas and the lean gas react (this temperature corresponds to the “predetermined temperature”), i.e., when the catalyst has not yet reached the temperature at which CO is able to be combusted, these gases may not sufficiently react, which may result in CO and HC and the like flowing through the catalyst. This kind of outflow of CO and HC and the like from the catalyst may also occur when rich gas and lean gas have not mixed sufficiently in the catalyst. That is, when rich gas and lean gas do not mix sufficiently, they are unable to react sufficiently, and as a result, CO and HC and the like may end up flowing out through the catalyst.

When the WGV 20 is open or when the speed of the turbine 4b in the turbocharger 4 (hereinafter referred to as the “turbine speed”) is low, it is highly likely that the rich gas and the lean gas will not mix sufficiently. This is because when the WGV 20 is open, exhaust gas flows through both the exhaust passage 18 on the turbine 4b side and the bypass passage 19, and when the turbine speed is low, a sufficient mixing effect of the gas in the turbine 4b is unable to be obtained. If CO and HC and the like are discharged as is from the catalyst as described above, it may adversely effect emissions.

Accordingly, in this example embodiment, the ECU 50 prohibits the fuel injection dither control from being executed when the catalyst temperature is less than the predetermined temperature. Moreover, when the catalyst temperature is less than the predetermined temperature, the ECU 50 continues to keep the WGV 20 open in order to improve the warm-up ability of the catalyst by increasing the flowrate directly to the catalyst and prevent heat from being removed by the turbine. Then when the catalyst temperature becomes equal to or greater than a predetermined temperature, i.e., when the catalyst temperature reaches a temperature at which CO is able to be combusted, the ECU 50 closes the WGV 20 and starts to execute the fuel injection dither control once the WGV 20 is closed. By executing the fuel injection dither control when the catalyst temperature is equal to or greater than a predetermined temperature in this way, CO produced by the fuel injection dither control is able to be reliably combusted in the catalyst (i.e., CO and O₂ are able to be reliably reacted). Also, by executing the fuel injection dither control when the WGV 20 is closed, exhaust gas is prevented from flowing into the bypass passage 19 which means that all of the exhaust gas generated during fuel injection dither control can be supplied to the turbine 4b. In addition, the turbine speed is increased which enables the rich gas and the lean gas to be effectively mixed at the turbine 4b. Accordingly, the rich gas and the lean gas can be appropriately mixed in the catalyst.

Furthermore, in this example embodiment, the ECU 50 determines the amount to increase and decrease the fuel injection quantity in the fuel injection dither control (hereinafter this amount will be referred to as the “fuel injection dither amplitude”) based on the turbine speed. In other words, the ECU 50 sets the amount to change the air-fuel ratio to the rich and lean sides according to the turbine speed. For example, the fuel injection dither amplitude is increased as the turbine speed increases. Changing the fuel injection dither amplitude in this way enables rich gas and lean gas of amounts according to the turbine speed to be supplied to the turbine 4b so that the rich gas and lean gas can be effectively mixed at the turbine 4b. As a result, the rich gas and the lean gas can be reliably mixed inside the catalyst.

Accordingly, by executing the fuel injection dither control according to this example embodiment, rich gas and lean gas are able to be reliably mixed within the catalyst and CO is able to be reliably combusted in the catalyst. Accordingly, the catalyst can be promptly warmed up while appropriately suppressing CO and HC and the like from flowing through the catalyst, i.e., while appropriately suppressing emissions from deteriorating due to the fuel injection dither control.

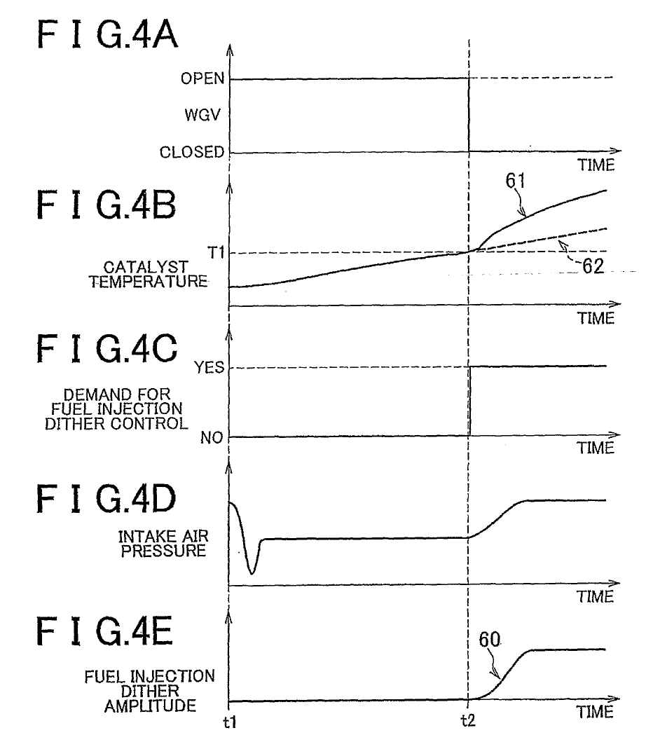

Next, the fuel injection dither control will be described in detail with reference to FIGS. 4A to 4E which are graphs showing the basic flow of the fuel injection dither control according to this example embodiment. FIG. 4A shows the opening and closing of the WGV 20. FIG. 4B shows the change over time in the catalyst temperature. FIG. 4C shows the demand for the fuel injection dither control. FIG. 4D shows the change over time in the intake air pressure, and FIG. 4E shows the change over time in the fuel injection dither amplitude. The horizontal axis in the drawings represents time.

At time t1, the engine 8 is started. In this case, from time t1 to time t2 the catalyst temperature is less than the predetermined temperature T1, as shown in FIG. 4B, so the ECU 50 keeps the WGV 20 open, as shown in FIG. 4A. Moreover, the ECU 50 does not output a demand for fuel injection dither control, as shown in FIG. 4C. In other words, the ECU 50 prohibits fuel injection dither control from being executed between time t1 and time t2 during which the catalyst temperature is less than the predetermined temperature T1.

At time t2, the catalyst temperature exceeds the predetermined temperature T1, as shown in FIG. 4B. Accordingly, the ECU 50 closes the WGV 20, as shown in FIG. 4A. Furthermore, when the WGV 20 is closed, the ECU 50 outputs a demand for fuel injection dither control, as shown in FIG. 4C. In this way, when the catalyst temperature is less than the predetermined temperature T1, fuel injection dither control is prohibited, and when the catalyst temperature becomes equal to or greater than the predetermined temperature T1, fuel injection dither control is started. As a result, the CO produced by the fuel injection dither control is able to be reliably combusted in the catalyst.

Also, closing the WGV 20 as described above increases the intake air pressure, as shown in FIG. 4D. Incidentally, there is a correlation between the intake air pressure and the turbine speed whereby the turbine speed rises as the intake air pressure increases. In this example embodiment, the ECU 50 sets the fuel injection dither amplitude in the fuel injection dither control based on the state of the intake air pressure. In this case, the intake air pressure gradually increases so the ECU 50 gradually increases the fuel injection dither amplitude, as shown by arrow 60 in FIG. 4E. Changing the fuel injection dither amplitude in this way enables the rich gas and the lean gas to be reliably mixed in the catalyst.

FIG. 4B shows both the result when this kind of fuel injection dither control is executed (shown by arrow 61) and the result when fuel injection dither control is not executed (shown by arrow 62). Accordingly, it is evident that the catalyst temperature increases faster when fuel injection dither control is executed than when it is not executed. It may therefore be said that the catalyst can be effectively warmed up with the fuel injection dither control according to this example embodiment.

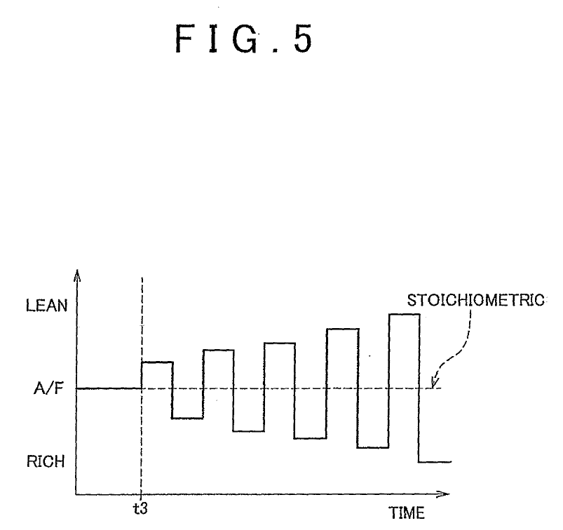

Here, an example when the fuel injection dither amplitude is changed in the fuel injection dither control will be described with reference to FIG. 5. In the graph shown in FIG. 5, the horizontal axis represents time and the vertical axis represents the air-fuel ratio (A/F). Incidentally, FIG. 5 is a graph illustrating a case in which fuel injection dither control is being executed while the intake air pressure is increasing, i.e., while the turbine speed is increasing. Also, this graph shows the change in the target air-fuel ratio.

As shown in FIG. 5, the ECU 50 performs fuel injection dither control from time t3. More specifically, the ECU 50 performs control that changes the fuel injection dither amplitude in the fuel injection dither control according to the change in the intake air pressure. In other words, the ECU 50 changes the amount that the air-fuel ratio swings to the rich side and the lean side depending on the change in the intake air pressure. In this case, the intake air pressure is increasing so the ECU 50 performs control to gradually increase the fuel injection dither amplitude. More specifically, the ECU 50 executes control to gradually increase the amount that the fuel injection quantity is increased in order to realize rich burn and gradually increase the amount that the fuel injection quantity is reduced in order to realize lean burn in the fuel injection dither control.

Changing the fuel injection dither amplitude in this way enables rich gas and lean gas of amounts according to the turbine speed to be supplied to the turbine 4b so rich gas and lean gas can be effectively mixed at the turbine 4b. Accordingly, the rich gas and the lean gas can be reliably mixed in the catalyst.

Incidentally, in the example described above, the fuel injection dither amplitude is determined (i.e., set) based on the turbine speed or the intake air pressure. However, the invention is not limited to this. In another example, the fuel injection dither amplitude can also be determined (i.e., set) based on at least one of the intake air amount, the intake air pressure (i.e., the intake pipe pressure), and the turbine speed.

Further, the fuel injection dither control according to this example embodiment can be executed in each bank when the engine 8 is a V type engine. That is, control is executed to make the cylinder group of one bank burn rich and make the cylinder group of the other bank burn lean.

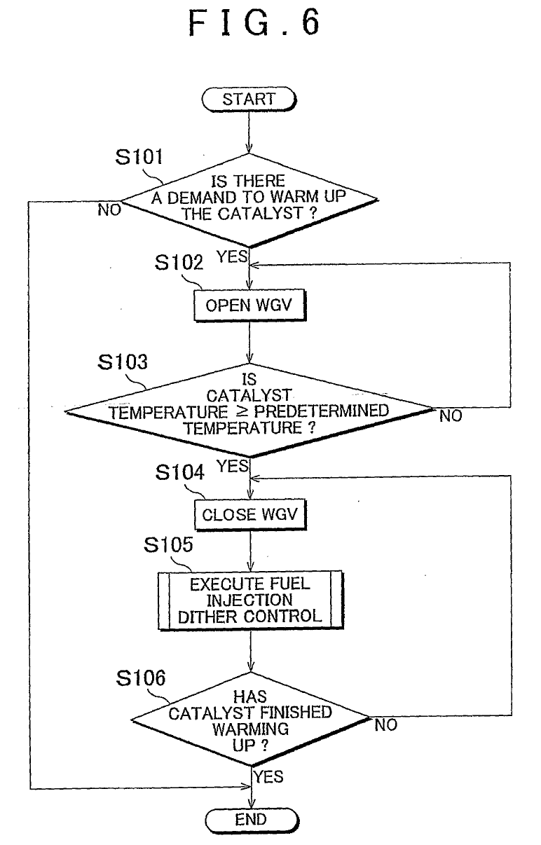

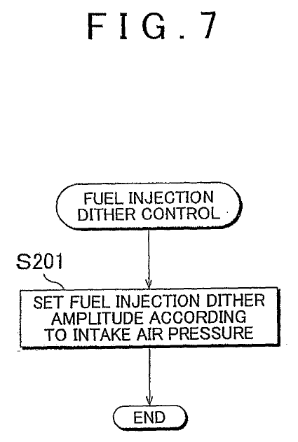

Next, a catalyst warm-up routine according to this example embodiment will be described with reference to FIGS. 6 and 7.

FIG. 6 is a flowchart illustrating the catalyst warm-up routine. This routine is performed to promptly warm up the catalyst at times such as during a cold start. More specifically, the fuel injection dither control and the like described above is performed. Incidentally, the ECU 50 repeatedly executes the catalyst warm-up routine at predetermined cycles.

First in step S01, the ECU 50 determines whether there is a demand to warm up the catalyst (i.e., a catalyst warm-up demand). In this case, the ECU 50 determines whether there is a catalyst warm-up demand by determining whether the engine 8 is idling during a cold start or whether the catalyst is warming up, for example. For example, the ECU 50 makes the determination based on the engine coolant temperature, the catalyst temperature (e.g., a detected or estimated value) and the like. When there is a catalyst warm-up demand (i.e., Yes in step S101), the process proceeds on to step S102. If there is not catalyst warm-up demand (i.e., No in step S101), the routine ends.

In step S102, the ECU 50 performs control to open the WGV 20. In this case, there is a catalyst warm-up demand so it is very likely that the catalyst temperature is less than a predetermined temperature. Accordingly, the ECU 50 opens the WGV 20 and the process proceeds on to step S103.

In step S103, the ECU 50 determines whether the catalyst temperature is equal to or greater Man a predetermined temperature. That is, the ECU 50 determines whether the catalyst temperature is a temperature at which CO in the exhaust gas will combust (i.e., a temperature at which O₂ and CO will react). The determination in step S103 is made in order to determine whether the WGV 20 can be closed and the fuel injection dither control is performed. If the catalyst temperature is equal to or greater than the predetermined temperature (i.e., Yes in step S103), the process proceeds on to step S104. If, on the other hand, the catalyst temperature is less than the predetermined temperature (i.e., No in step S103), the process returns to step S102. In this case, the ECU 50 keeps the WGV 20 open. That is, the ECU 50 performs control to keep the WGV 20 open until the catalyst temperature becomes equal to or greater than the predetermined temperature.

In step S104, the ECU 50 performs control to close the WGV 20. In this case, the catalyst temperature is equal to or greater than the predetermined temperature so it can be said that CO will burn appropriately in the catalyst. Accordingly, it can be said that no problems would occur if the fuel injection dither control was executed. Therefore, the ECU 50 performs control to close the WGV 20 before the fuel injection dither control starts. Closing the WGV 20 in this way increases the turbine speed which makes it possible to efficiently mix the rich gas and the lean gas that are produced as a result of executing the fuel injection dither control. The process then proceeds on to step S105.

In step S105, the ECU 50 executes fuel injection dither control because the WGV 20 is closed. The details of the step in which this control is performed will be described later. Once the fuel injection dither control ends, the process proceeds on to step S106. In step S106, the ECU 50 determines whether the catalyst has finished warming up. For example, the ECU 50 determines whether the catalyst temperature (e.g., a detected or estimated value) has become equal to or greater than a target temperature. If the catalyst has finished warming tip (i.e., Yes in step S106), the routine ends. If, on the other hand, the catalyst has not finished warming up (i.e., No in step S106), the process returns to step S104. In this case, the fuel injection dither control is executed again while the WGV 20 remains closed. That is, the fuel injection dither control continues to be executed until the catalyst has finished warming up.

Next, the fuel injection dither control that is executed in step S105 described above will be described with reference to FIG. 7 which is a flowchart of the fuel injection dither control. In this control, the ECU 50 basically performs control to increase and decrease the fuel injection quantity so that lean burn and rich burn are performed alternately for each cylinder 8a or each predetermined period of time.

In step S201, the ECU 50 sets the fuel injection dither amplitude according to the intake air pressure and executes fuel injection dither control based on that set fuel injection dither amplitude. More specifically, the ECU 50 sets the fuel injection dither amplitude based on the intake air pressure obtained from the intake air pressure sensor 31 and controls the fuel injection valve 10 so that a fuel injection quantity corresponding to that fuel injection dither amplitude is injected. For example, the ECU 50 sets a fuel injection dither amplitude with an increasingly larger value as the intake air pressure increases, i.e., as the turbine speed increases. Setting the fuel injection dither amplitude and executing the fuel injection dither control in this way enables rich gas and lean gas of amounts according to the turbine speed to be supplied to the turbine 4b. As a result, rich gas and lean gas are able to be reliably-mixed in the catalyst. Once this step is complete, the process ends. Incidentally, a limit value may also be provided for the fuel injection dither amplitude. That is, when the fuel injection dither amplitude has reached the limit value, the fuel injection dither amplitude can continue to be maintained at that limit value even if the intake air pressure increases further.

In this way, the catalyst warm-up routine according to this example embodiment enables rich gas and lean gas to be reliably mixed in the catalyst, as well as enables CO and O₂ to reliably react in the catalyst. Accordingly, the catalyst can be promptly warmed up while appropriately suppressing CO and HC and the like from flowing through the catalyst, i.e., while appropriately suppressing emissions from deteriorating due to the fuel injection dither control.

While the invention has been described with reference to example embodiments thereof, it is to be understood that the invention is not limited to the example embodiments or constructions. To the contrary, the invention is intended to cover various modifications and equivalent arrangements. In addition, while the various elements of the example embodiments are shown in various combinations and configurations, which are exemplary, other combinations and configurations, including more, less or only a single element, are also within the spirit and scope of the invention.

1. A control apparatus of an internal combustion engine, comprising:
a wastegate valve control portion that controls the opening and closing of a wastegate valve provided in a bypass passage that connects a portion of an exhaust passage upstream of a supercharger with a portion of the exhaust passage downstream of the supercharger, thereby bypassing the supercharger; and
a fuel injection control portion that controls an increase and decrease of a fuel injection quantity,
wherein the wastegate valve control portion keeps the wastegate valve open when a temperature of a catalyst provided in the exhaust passage is less than a predetermined temperature and closes the wastegate valve when the temperature of the catalyst becomes equal to or greater than the predetermined temperature, and
the fuel injection control portion increases and decreases the fuel injection quantity such that the internal combustion engine alternately switches between lean burn and rich burn when the wastegate valve is closed by the wastegate valve control portion.

2. The control apparatus according to claim 1, wherein the fuel injection control portion prohibits control that increases and decreases the fuel injection quantity when the catalyst temperature is less than the predetermined temperature.

3. The control apparatus according to claim 1, wherein the internal combustion engine is provided with a plurality of cylinders, and the fuel injection control portion performs control to alternately increase and decrease the fuel injection quantity such that each cylinder of the internal combustion engine alternately switches between lean burn and rich burn.

4. The control apparatus according to claim 1, wherein the internal combustion engine is provided with a plurality of cylinder groups in which a plurality of cylinders are arranged divided into two banks, and the fuel injection control portion increases and decreases the fuel injection quantity such that rich burn is performed in the cylinder group forming one bank and lean burn is performed in the cylinder group forming the other bank alternately.

5. The control apparatus according to claim 1, wherein the fuel injection control portion increases and decreases the fuel injection quantity such that the internal combustion engine alternately switches between lean burn and rich burn every predetermined period of time.

6. The control apparatus according to claim 1, wherein the fuel injection control portion sets the amount of increase and decrease of the fuel injection quantity based on at least one of an intake air amount, an intake pipe pressure, and a turbine speed of the supercharger.

7. The control apparatus according to claim 1, wherein the fuel injection control portion increases the amount of increase and decrease of the fuel injection quantity as the intake pipe pressure increases.

8. The control apparatus according to claim 1, wherein the fuel injection control portion increases the amount of increase and decrease of the fuel injection quantity as the turbine speed of the supercharger increases.

9. The control apparatus according to claim 6, wherein the fuel injection control portion provides a predetermined limit value for the fuel injection quantity and sets the amount of increase and decrease of the fuel injection quantity such that the fuel injection quantity is maintained at the limit value when the fuel injection quantity reaches the limit value.

10. The control apparatus according to claim 1, wherein the predetermined temperature is a temperature at which CO in the exhaust gas is able to combust in the catalyst.

11. A control method for an internal combustion engine having a supercharger and a wastegate valve provided in a bypass passage that connects a portion of an exhaust passage upstream of the supercharger with a portion of the exhaust passage downstream of the supercharger, thereby bypassing the supercharger, by comprising:
keeping the wastegate valve open when a temperature of a catalyst provided in the exhaust passage is less than a predetermined temperature and closing the wastegate valve when the temperature of the catalyst becomes equal to or greater than the predetermined temperature; and
increasing and decreasing the fuel injection quantity such that the internal combustion engine alternately switches between lean burn and rich burn when the wastegate valve is closed.

12. A control apparatus of an internal combustion engine having a supercharger and a wastegate valve provided in a bypass passage that connects a portion of an exhaust passage upstream of the supercharger with a portion of the exhaust passage downstream of the supercharger, thereby bypassing the supercharger, by comprising:
wastegate valve controlling means for controlling the opening and closing of the wastegate valve; and
fuel injection controlling means for controlling an increase and decrease of a fuel injection quantity,
wherein the wastegate valve controlling means keeps the wastegate valve open when a temperature of a catalyst provided in the exhaust passage is less than a predetermined temperature and closes the wastegate valve when the temperature of the catalyst becomes equal to or greater than the predetermined temperature, and
the fuel injection controlling means increases and decreases the fuel injection quantity such that the internal combustion engine alternately switches between lean burn and rich burn when the wastegate valve is closed by the wastegate valve controlling means.

13. The control apparatus according to claim 7, wherein the fuel injection control portion provides a predetermined limit value for the fuel injection quantity and sets the amount of increase and decrease of the fuel injection quantity such that the fuel injection quantity is maintained at the limit value when the fuel injection quantity reaches the limit value.

14. The control apparatus according to claim 8, wherein the fuel injection control portion provides a predetermined limit value for the fuel injection quantity and sets the amount of increase and decrease of the fuel injection quantity such that the fuel injection quantity is maintained at the limit value when the fuel injection quantity reaches the limit value.
